(19) United States
(12) Patent Application Publication
(10) Pub. No.: US 2024/0100660 A1
(43) Pub. Date: Mar. 28, 2024

(54) Tool Holder for a Hand-Held Power Tool

(71) Applicant: Robert Bosch GmbH, Stuttgart (DE)

(72) Inventor: Han Hoong Sebastian Chin, Penang (MY)

(21) Appl. No.: 18/473,792

(22) Filed: Sep. 25, 2023

(30) Foreign Application Priority Data
Sep. 28, 2022 (DE) 10 2022 210 252.5

(51) Int. Cl. B25B 23/00; B25B 21/00

(52) U.S. Cl. CPC B25B 23/0035; B25B 21/00

(57) ABSTRACT

A tool holder for a hand-held power tool includes an at least partially tubular base body, which forms an inner holder for receiving an insertion tool, in particular a bit insertion tool. The tool holder further includes a locking device for releasable locking of the insertion tool, which is arranged in the inner holder. The locking device features a locking sleeve and a locking element. The locking sleeve is movable to a locked position along a longitudinal extension of the at least partially tubular base body with the aid of a spring element. The locking sleeve features a contact element at least in sections on its inner circumference, and the at least approximately tubular base body features a fixing element on its outer circumference. The spring element acts upon the fixing element against the contact element.

This application claims priority under 35 U.S.C. § 119 to patent application no. DE 10 2022 210 252.5, filed on Sep. 28, 2022 in Germany, the disclosure of which is incorporated herein by reference in its entirety.

### BACKGROUND

The disclosure relates to a tool holder for a hand-held power tool, having an at least partially tubular base body which forms an inner holder for receiving an insertion tool, in particular a bit insertion tool, and having a locking device for releasable locking of an insertion tool, in particular a bit insertion tool, which can be arranged in the inner holder, wherein the locking device features a locking sleeve and a locking element.

Such a tool holder for a hand-held power tool is known from the prior art. The tool holder features an at least partially tubular base body with an inner holder. The inner holder is formed to receive an insertion tool, in particular a bit insertion tool, and a locking device is provided for releasable locking of an insertion tool that can be arranged in the inner holder. The locking device features a locking sleeve and a locking element.

### SUMMARY

The disclosure relates to a tool holder for a hand-held power tool, having an at least partially tubular base body which forms an inner holder for receiving an insertion tool, in particular a bit insertion tool, and having a locking device for releasable locking of an insertion tool, in particular a bit insertion tool, which can be arranged in the inner holder, wherein the locking device features a locking sleeve and a locking element. The locking sleeve is loaded into a locked position along a longitudinal extension of the at least partially tubular base body by means of a spring element, wherein the locking sleeve features a contact element at least in sections on its inner circumference and the at least approximately tubular base body features a fixing element on its outer circumference, wherein the spring element loads the fixing element against the contact element.

The disclosure thus makes it possible to provide a tool holder for a hand-held power tool, in which the locking device can make it possible to lock an insertion tool arranged in the tool holder securely and reliably.

Preferably, a blocking element is associated with the locking sleeve, wherein the spring element is arranged between the blocking element and the fixing element.

This enables a compact and space-saving design of the tool holder.

Preferably, the spring element is in contact with the blocking element in the circumferential direction of the at least partially tubular base body and/or along the longitudinal extension.

Thus, a simple and uncomplicated arrangement of the spring element can be made possible.

The blocking element is preferably displaceable along the longitudinal extension on an outer circumference of the at least partially tubular base body and/or rotatable in the circumferential direction of the at least partially tubular base body.

This makes it easy and uncomplicated to arrange the locking sleeve in a locked position and an unlocked position.

Preferably, a terminating element is associated with the blocking element, wherein the terminating element is arranged in a receptacle arranged on the inner circumference of the locking sleeve.

Thus, an arrangement of the blocking element radially between the locking sleeve and the tubular base body can be made possible in a simple manner.

Preferably, the blocking element is arranged along the longitudinal extension between the spring element and the terminating element.

Thus, a safe and reliable arrangement of the blocking element can be made possible.

Preferably, the contact element rests against the fixing element along the longitudinal extension and/or in the circumferential direction of the at least partially tubular base body.

Thus, a stable and robust arrangement of the contact element can be made possible.

According to one embodiment, the spring element rests against the fixing element along the longitudinal extension and/or in the circumferential direction.

Thus, effective support of the spring element on the fixing element can be made possible.

The fixing element is preferably arranged along the longitudinal extension between the contact element and the spring element.

Thus, an arrangement of the fixing element can be made possible in a simple manner.

Preferably, the contact element is arranged along the longitudinal extension between a receiving area for receiving the locking element and the fixing element.

Thus, safe and reliable arrangement of the contact element can be made possible.

Preferably, the locking sleeve features a guide section for guiding the locking element on its inner circumference facing the at least partially tubular base body, wherein the receiving area is arranged along the longitudinal extension between the guide section and the contact element.

This makes it easy and uncomplicated to enable an unlocked position of the locking sleeve.

Preferably, the inner holder features a first area associated with a free end of the inner holder and having a first diameter, and a second area facing away from the free end and having a second diameter, wherein the second diameter is smaller than the first diameter, and wherein an outer circumference of an insertion tool can be arranged in the first area.

This makes it possible to easily arrange different insertion tools in the inner holder.

A machining section of a double-headed bit can preferably be arranged in the second area.

Thus, a double-headed bit can be safely and reliably arranged in the inner holder.

In addition, the disclosure relates to a hand-held power tool having a tool holder as described above.

### BRIEF DESCRIPTION OF THE DRAWINGS

The disclosure is explained in further detail in the following description with reference to exemplary embodiments shown in the drawings. Shown are:

FIG. 1 is a side view of a hand-held power tool according to the disclosure with a tool holder according to the disclosure,

FIG. 2A is a side view of a first bit insertion tool,

FIG. 2B is a side view of a second bit insertion tool,

FIG. 2C is a side view of a third bit insertion tool,

FIG. 2D is a side view of a fourth bit insertion tool,

FIG. 2E is a side view of a fifth bit insertion tool,

FIG. 3 is a longitudinal section through the tool holder of FIG. 1 with a bit insertion tool of FIGS. 2A-2E in a locked position,

FIG. 4 is a longitudinal section through the tool holder of FIG. 1 and FIG. 3 with a bit insertion tool of FIGS. 2A-2E in the locked position,

FIG. 5 is a longitudinal section through the tool holder of FIG. 1, FIG. 3 and FIG. 4 with a bit insertion tool of FIGS. 2A-2E in the locked position,

FIG. 6 is a longitudinal section through the tool holder of FIG. 5 in the locked position, with the insertion tool of FIG. 5 fixed at an alternative fixing point,

FIG. 7 is a longitudinal section through the tool holder of FIG. 5 and FIG. 6 when the insertion tool of FIG. 5 and FIG. 6 is loaded from the tool holder,

FIG. 8 is a longitudinal section through the tool holder of FIG. 5 to FIG. 7 in the locked position of FIG. 5,

FIG. 9 is a longitudinal section through the tool holder of FIG. 1 and FIG. 3 to FIG. 8 with a bit insertion tool of FIGS. 2A-2E in the locked position,

FIG. 10 is a longitudinal section through the tool holder of FIG. 1 and FIG. 3 to FIG. 9 with a locking device, and

FIG. 11 is an exploded perspective view of the tool holder of FIG. 1 and FIG. 3 to FIG. 10.

### DETAILED DESCRIPTION

Elements having the same or a comparable function are provided with the same reference numerals in the figures and are described in detail only once.

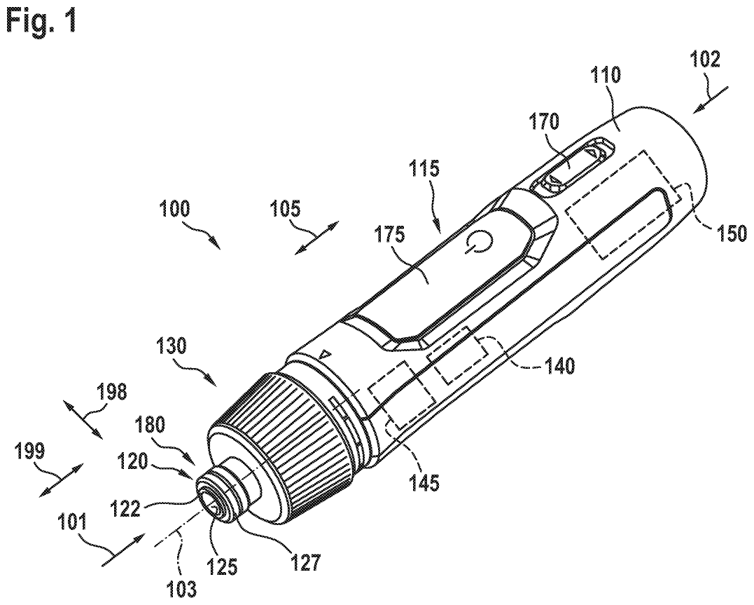

FIG. 1 illustrates an exemplary hand-held power tool 100, which, as an illustration, features an elongated housing 110. Thus, with the elongated housing 110, the hand-held power tool 100 is formed by way of example in the so-called “rod shape.” Preferably, the hand-held power tool 100 is formed as a screwdriver, in particular as a rod screwdriver. According to one embodiment, the hand-held power tool 100 can be mechanically and electrically connected to a drive unit 150 for network-independent power supply. Preferably, the power supply unit 150 is formed as a battery pack.

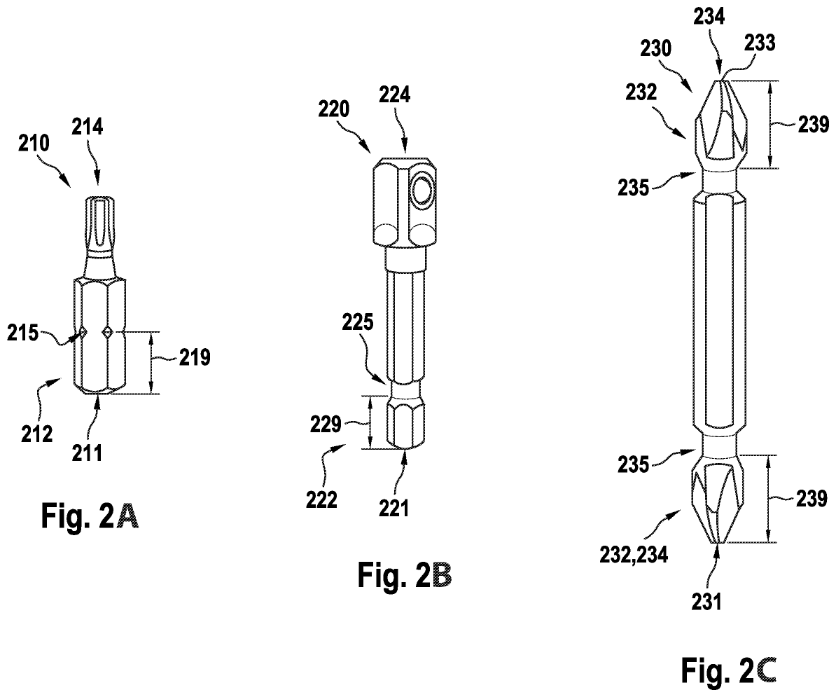

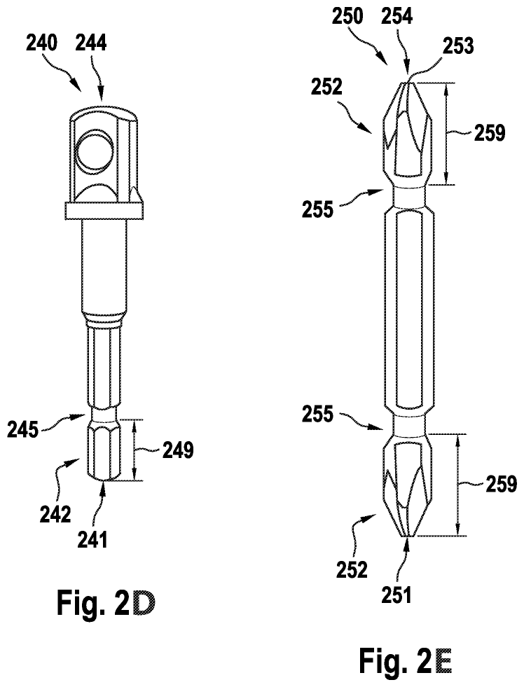

The elongated housing 110 preferably comprises at least one drive motor 140 for driving a tool holder 120. Preferably, the tool holder 120 features an at least partially tubular or sleeve-shaped base body 122. The at least partially tubular base body 122 preferably features an inner holder 125 for receiving an insertion tool (210-250 in FIGS. 2A, 2B, 2C, 2D, and 2E). Preferably, the inner holder 125 is an inner hexagonal receptacle for a screwdriver bit or bit insertion tools in general (210-250 in FIGS. 2A, 2B, 2C, 2D, and 2E).

The elongated housing 110 preferably features an at least approximately cylindrical body with a first axial end 101 and an opposite second axial end 102, wherein the tool holder 120 is arranged in the area of the first axial end 101, by way of example. As an illustration, a longitudinal direction 105 of the elongated housing 110 is formed between the first and second axial ends 101, 102.

In the hand-held power tool 100 shown in FIG. 1, the tool holder 120, the drive motor 140, and the housing 110 having a handle area 115 and a cover 117 are arranged along a common longitudinal axis that is preferably aligned coaxially with an axis of rotation 103 of the tool holder 120. Preferably, all elements of the hand-held power tool 100 are arranged in the elongated housing 110. Thus, compared to a hand-held power tool with a pistol-shaped housing in which the battery pack is arranged perpendicular to the drive motor, which is sufficiently known from the prior art, the battery pack 150 is also preferably arranged in the housing 110 in the hand-held power tool 100.

According to one embodiment, a gearbox 145 is associated with the drive motor 140. Preferably, the transmission 145 is formed as a planetary gear train. Furthermore, a sliding switch 170 is preferably provided, which is arranged on the housing 110 in order to activate a reversing operation of the drive motor 140. Likewise, the housing 110 preferably features an optional torque adjustment sleeve 130 at its axial end 101. Moreover, the cover 117 is preferably arranged on the axial end 102 of the elongated housing 110 facing away from the tool holder 120.

According to one embodiment, a control element 175 is provided for activating the drive motor 140. An operation of the control element 175 by a user preferably activates the drive motor 140.

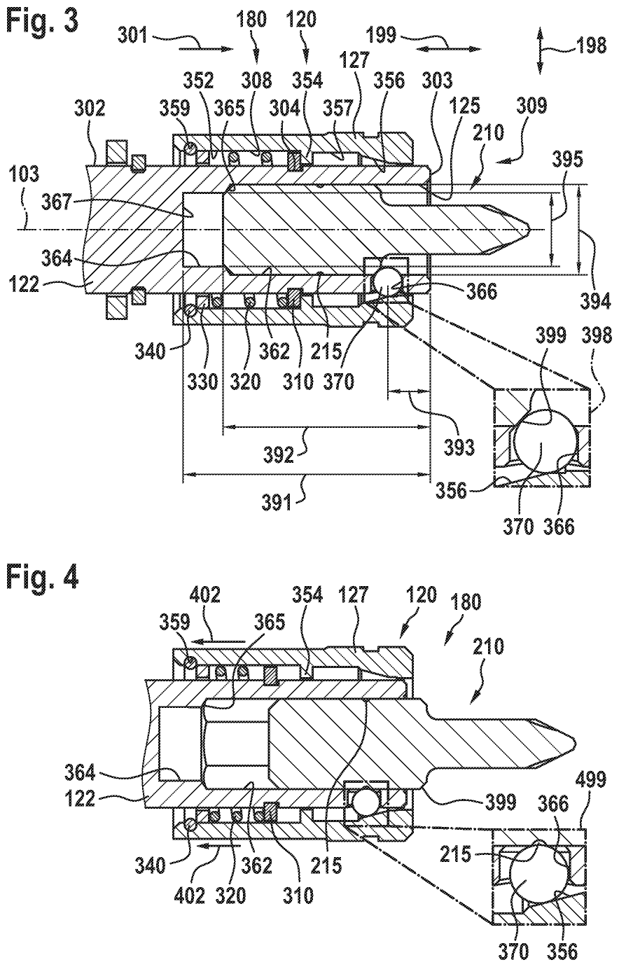

Preferably, a locking device 180 is provided for releasable locking of an insertion tool (210 in FIG. 2A, 220 in FIG. 2B, 230 in FIG. 2C, 240 in FIG. 2D, and 250 in FIG. 2E) that can be arranged in the inner holder 125. The locking device 180 preferably features a locking sleeve 127 and a locking element (370 in FIG. 3), wherein the locking element (370 in FIG. 3) can be loaded in sections into the inner holder 125 for locking by the locking sleeve 127.

As an illustration, the tool holder 120 features a radial direction 198 and a longitudinal extension 199. It is noted that in the context of the disclosure, the term “radial” is understood to mean a direction approximately perpendicular to the longitudinal extension 199 of the tool holder 120. Further, the term “axial” is understood to mean a direction along the longitudinal extension 199 of the tool holder 120. Thus, the radial direction 198 is approximately perpendicular to the longitudinal direction 105 of the elongated housing 110 or perpendicular to the longitudinal extension 199 of the tool holder 120. Further, the axial direction is substantially parallel to the longitudinal extension 199 of the tool holder 120 or parallel to the axis of rotation 103 of the tool holder 120.

FIGS. 2A, 2B, 2C, 2D, and 2E shows five different insertion tools 210, 220, 230, 240, 250 for arrangement in the tool holder 120 of FIG. 1. Each of the insertion tools 210-250 as an illustration features a receiving area 212, 222, 232, 242, 252 with a fixing point 215, 225, 235, 245, 255 and a machining section 214, 224, 234, 244, 254 for releasable connection to a tool or screw. The insertion tools 210-230 are preferably formed in the manner of European insertion tools and the insertion tools 240, 250 are preferably formed in the manner of Asian insertion tools.

The insertion tool 210, which is preferably formed as a short bit, features an exemplary end face 211 on which the receiving section 212 is arranged. At a distance 219 from the end face 211 is the fixing point 215. The distance 219 is preferably 8 mm. The fixing point 215 is preferably formed as a notch. Opposite from the end face 211 is the machining section 214. As an illustration, the machining section 214 is formed as an internal serrated bit.

The insertion tool 220, which is preferably formed as a socket adapter bit, as an illustration features an end face 221 on which the receiving section 222 is arranged. At a distance 229 from the end face 221 is the fixing point 225. The distance 229 is preferably 9 mm. The fixing point 225 is preferably formed as a groove. The fixing point 225 preferably features a diameter of 5 mm. Opposite from the end face 221 is the machining section 224. As an illustration, the machining section 224 is formed as a socket adapter.

The insertion tool 230, which is preferably formed as a double-headed bit, features one end face 231 and an opposite end face 233, wherein a machining section 234, which is formed as a screwdriver bit and can also serve as a receiving section 232, is arranged on each end face 231, 233. A fixing point 235 is arranged at a distance 239 from each of the end faces 231, 233. The fixing points 235 are preferably formed as a groove and preferably each feature a diameter of 5 mm.

The insertion tool 240, which is preferably formed as a socket adapter bit, features an end face 241 on which the receiving section 242 is arranged. At a distance 249 from the end face 241, the fixing point 245 is arranged. The fixing point 245 is preferably formed as a groove. The fixing point 245 preferably features a diameter of 5 mm. Opposite from the end face 241 is the machining section 244. As an illustration, the machining section 244 is formed as a socket adapter. Compared to the insertion tool 220, the insertion tool 240 features a machining section 244 with larger dimensions. Furthermore, the distance 249 is larger compared to the insertion tools 210-230 and is preferably 13 mm.

The insertion tool 250, which is preferably formed as a double-headed bit, has one end face 251 and an opposite end face 253, wherein a machining section 254, which is formed as a screwdriver bit and can also serve as a receiving section 252, is arranged on each end face 251, 253. A fixing point 255 is arranged at a distance 259 from each of the end faces 251, 253. The fixing points 255 are preferably formed as grooves and preferably each feature a diameter of 5 mm.

FIG. 3 shows the tool holder 120 of FIG. 1 with the insertion tool 210 of FIG. 2A and illustrates the locking device 180 of FIG. 1 of the tool holder 120. The at least partially tubular or sleeve-shaped base body 122 of the tool holder 120 features the inner holder 125, which as an illustration features first and second areas 362, 364 and a bottom surface 367. Preferably, the first area 362 is arranged at a free end 309 of the inner holder 125, or facing an end face 303 of the base body 122. Further, the second area 364 is arranged facing away from the free end 309, or arranged facing the bottom surface 367. In particular, the second area 364 is, as an illustration, formed as a cup with the bottom surface 367.

Preferably, the first area 362 features a first diameter 394 and the second area 364 features a second diameter 395. Preferably, the second diameter 395 is smaller than the first diameter 394. Preferably, the first diameter 394 reduces into the second diameter 395 via an inner leading edge 365. The inner leading edge 365 is arranged in the direction of the longitudinal extension 199, or axially at a distance 392 of at least 17 mm, from the end face 303.

According to one embodiment, the first diameter 394 is at least 8 mm. Preferably, an outer circumference or outer contour of an insertion tool 210 of FIG. 2A, 220 of FIG. 2B, 230 of FIG. 2C, 240 of FIG. 2D, and 250 of FIG. 2E is arranged in the first area 362. The bottom surface 367 is arranged in the direction of the longitudinal extension 199 or axially at a distance 391 of at least 20 mm from the end face 303. Preferably, a machining section 234, 254 of a double-headed bit 250 of FIG. 2E is arranged in the second area 364.

Preferably, the at least partially tubular base body 122 features at least one recess 366 arranged radially with respect to the inner holder 125. Preferably, the recess 366 is formed as a hollow cylinder. The locking element 370 is arranged in the recess 366. The recess 366 is preferably arranged in the area of a free end 309 of the at least partially tubular base body 122. Here, the recess 366 is arranged away from the end face 303, formed at the free end 309, of the at least partially tubular base body 122 in the direction of the longitudinal extension 199 of the base body 122 by a predetermined distance 393. Preferably, the predetermined distance 393 is less than 5 mm, particularly preferably 3.5 mm.

In addition, the at least approximately tubular base body 122 preferably features a circumferential groove 304 on its outer circumference 302. Preferably, the outer circumference 302 is substantially cylindrical. Preferably, a fixing element 310 associated with the locking device 180 is arranged in the circumferential groove 304. The fixing element 310 is preferably formed as a C-clip. In the following, the at least approximately tubular base body will be referred to only as “base body 122” for simplicity.

As described above, the locking device 180 features a locking sleeve 127 and a locking element 370. The locking sleeve 127 is arranged on the outer circumference 302 of the base body 122. For this purpose, the locking sleeve 127 features an inner holder on its inner circumference 308, which is not further marked for clarity. The inner holder features a spring receiving section 352 and a receiving area 357 for receiving the locking element 370. The spring receiving section 352 and the receiving area 357 are preferably axially separated from each other by a contact element 354. As an illustration, the contact element 354 is formed at least in sections on the inner circumference 308 of the locking sleeve 127. In this case, the contact element 354 is formed as an extension radially inward, or toward the axis of rotation 103, which features a smaller inner diameter than the spring receiving section 352 and/or the receiving area 357. Furthermore, a guide section 356 for guiding the locking element 370 is exemplarily associated with the receiving area 357.

The receiving area 357 is preferably arranged along the longitudinal extension 199 between the guide section 356 and the contact element 354. Here, the guide section 356 is preferably formed as a ramp that increases an inner diameter of the locking sleeve 127 from the end face 303 toward the contact element 354.

As an illustration, one locking element 370 is shown in FIG. 3, but multiple locking elements 370 may be arranged in the circumferential direction of the tool holder 120. In this case, the receiving area 357 and the guide section 356 can be formed continuously in the circumferential direction of the tool holder 120 or can be formed only in the area of the locking element 370. Preferably, the locking element 370 is formed spherical and features a diameter of at least 2.4 mm.

The locking sleeve 127 is preferably loaded into the locked position along the longitudinal extension 199 of the base body 122 by means of a spring element 320. In this case, the spring element 320 is arranged in the spring receiving section 352. Preferably, the spring element 320 axially compresses the fixing element 310 against the contact element 354.

Furthermore, a blocking element 330 is preferably associated with the locking sleeve 127. Preferably, the blocking element 330 is displaceable along the longitudinal extension 199 on an outer circumference 302 of the base body 122 and/or rotatable in the circumferential direction of the base body 122. The spring element 320 is preferably arranged axially between the blocking element 330 and the fixing element 310. Furthermore, the spring element 320 preferably bears against the blocking element 330 in the circumferential direction of the base body 122 and/or along the longitudinal extension 199.

Preferably, a terminating element 340 is associated with the blocking element 330, the terminating element 340 being arranged in a receptacle 359 arranged on the inner circumference 308 of the locking sleeve 127. Preferably, the terminating element 340 is formed as a C-ring or snap ring. Here, the blocking element 330 is preferably arranged axially along the longitudinal extension 199 between the spring element 320 and the terminating element 340.

The contact element 354 preferably abuts the fixing element 310 along the longitudinal extension 199 and/or in the circumferential direction of the base body 122. Here, the spring element 320 is preferably in contact with the fixing element 310 along the longitudinal extension 199 and/or in the circumferential direction. Preferably, the fixing element 310 is axially arranged along the longitudinal extension 199 between the contact element 354 and the spring element 320. Further, the contact element 354 is preferably arranged along the longitudinal extension 199 between a receiving area 357 for receiving the locking element 370 and the fixing element 310.

Preferably, the locking sleeve 127 is loaded axially or along the longitudinal extension 199 towards the end face 303 by means of the spring element 320 and unlocking occurs against the spring force associated with the spring element 320. As an illustration, unlocking occurs in the direction of an arrow 301 toward the end face 303.

In a magnified area 398, FIG. 3 illustrates a locking of the insertion tool 210 in the inner holder 125 of the base body 122. In this case, the locking element 370, which is arranged in sections in the inner holder 125, as an illustration, loads the insertion tool 210 into the inner holder 125 at a leading edge 399, in particular against the inner leading edge 365.

FIG. 4 shows the tool holder 120 with the insertion tool 210 of FIG. 3. In this case, the insertion tool 210 is fixed at the fixing point 215 by the locking element 370 in the tool holder 120 or the base body 122, as an example. The spring element 320 is thereby preferably compressed and forms a spring force in the direction of the arrows 402, which acts on the locking element 370.

In a magnified area 499, FIG. 4 illustrates the arrangement of the locking element 370 at the fixing point 215 of the insertion tool 210. Here, the locking element 370 is, as an illustration, arranged in the guide section 356 of the locking sleeve 127.

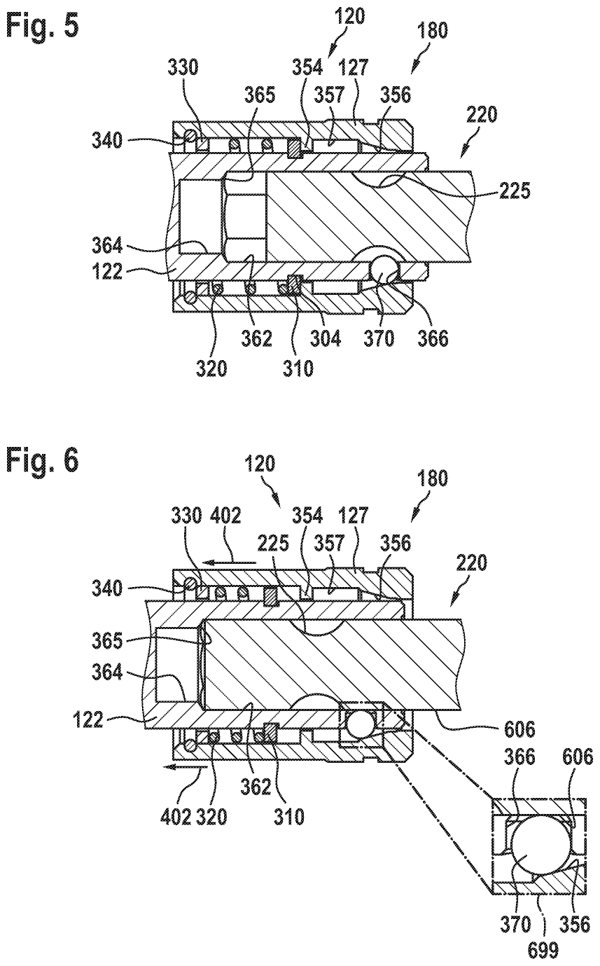

FIG. 5 shows the tool holder 120 of FIG. 3 and FIG. 4 with the insertion tool 220 of FIG. 2B. As an illustration, the insertion tool 220 is fixed at the fixing point 225, which is formed as a circumferential groove, by the locking element 370 in the tool holder 120 or the base body 122. Here, the locking element 370 preferably protrudes into the inner holder 125 and is arranged in sections in the fixing point 225. Here, too, the locking element 370 is arranged in the guide section 356 of the locking sleeve 127.

FIG. 6 shows the tool holder 120 with the insertion tool 220 of FIG. 5, wherein the insertion tool 220 is, as an illustration, loaded at its outer circumference 606 by the locking element 370 for fixing in the base body 122. Analogous to FIG. 4, the spring element 320 is thereby compressed and forms a spring force in the direction of the arrows 402, which acts on the locking element 370.

In a magnified area 699, FIG. 6 illustrates an example of the arrangement of the locking element 370 on the outer circumference 606 of the insertion tool 220. Here, the locking element 370 is arranged in the guide section 356 of the locking sleeve 127.

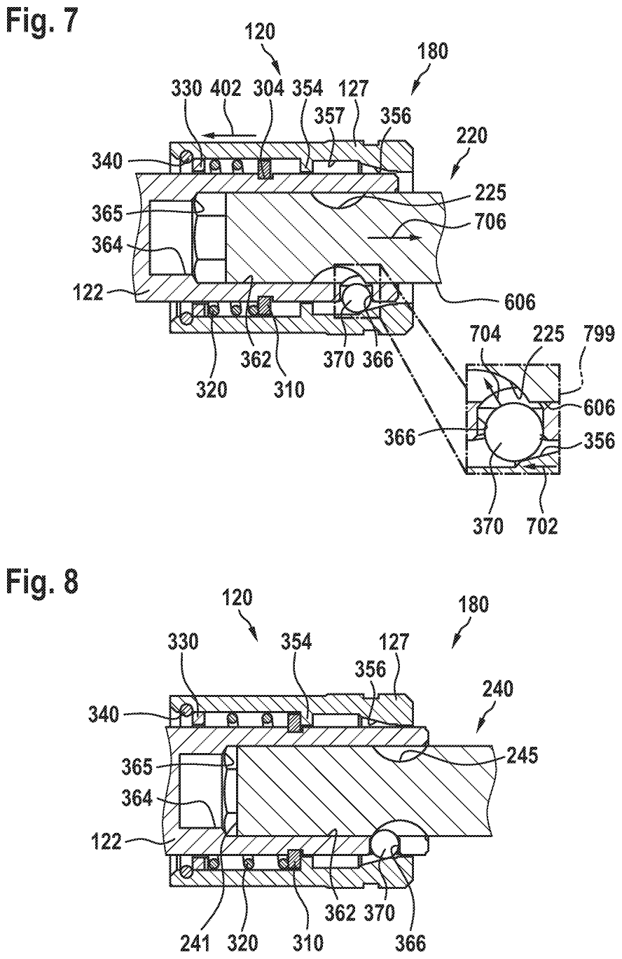

FIG. 7 shows the tool holder 120 with the insertion tool 220 of FIG. 6, wherein the insertion tool 220 is, as an illustration, loaded due to a comparatively low fixation by loading the locking element 370 on the outer circumference 606 of the insertion tool 220 along an arrow 706, or out of the base body 122. This causes the locking element 370, as shown in a magnified area 799, to move first in the direction of an arrow 702 along the outer circumference 606 of the insertion tool 220 and then radially into the fixing point 225 along an arrow 704, thereby fixing the insertion tool 220 as shown in FIG. 5.

FIG. 8 shows the tool holder 120 of FIG. 3 to FIG. 7 with the insertion tool 240 of FIG. 4 in the locked position. Here, the locking element 370 for locking the insertion tool 240 is, as an illustration, arranged in sections in the fixing point 245 of the insertion tool 240.

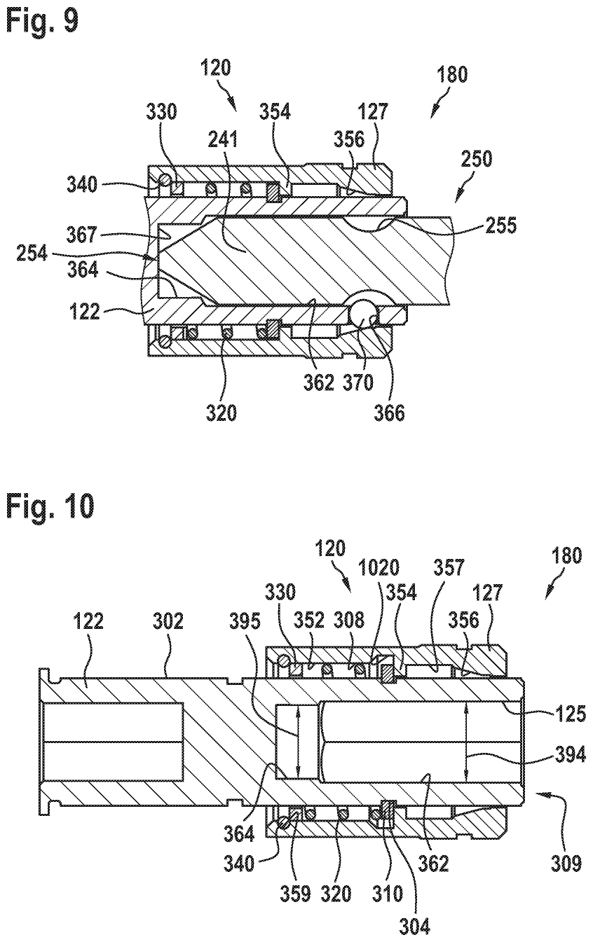

FIG. 9 shows the tool holder 120 of FIG. 3 to FIG. 8 with the insertion tool 250 of FIG. 4 in the locked position. Here, the locking element 370 for locking the insertion tool 250 is, as an illustration, arranged in sections in the fixing point 255 of the insertion tool 250. Furthermore, in this case, the machining section 254 is arranged in the second area 364 and, in particular, abuts the bottom surface 367.

FIG. 10 shows the tool holder 120 with the locking device 180 of FIG. 3 to FIG. 9. In this regard, FIG. 10 illustrates the locking sleeve 127 which, according to another embodiment, as an illustration, features a recess 1020 to the left of the contact element 354. In this regard, the recess 1020 features a larger diameter than the spring receiving section 352 and/or the receiving area 357.

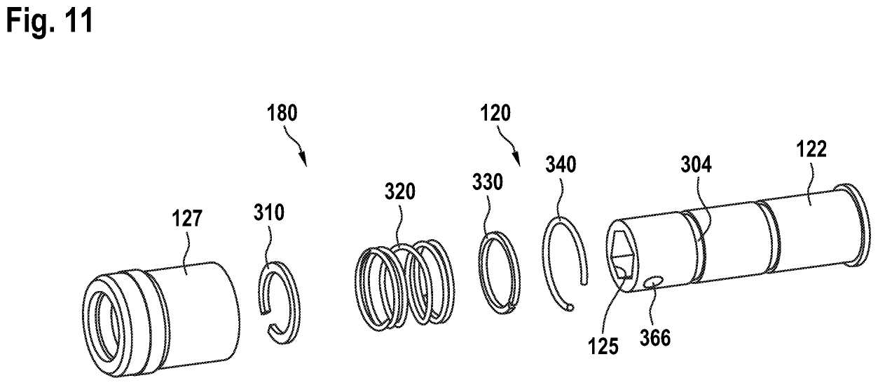

FIG. 11 shows the tool holder 120 with the locking device 180 of FIG. 10, illustrating the fixing element 310 and terminating element 340, which are, as an illustration, formed as a C-clip, and the blocking element 330, which is exemplarily formed as a snap ring. In addition, FIG. 11 illustrates the circumferential groove 304 formed on the outer circumference 302 of the base body 122.

1. A tool holder for a hand-held power tool, comprising;
an at least partially tubular base body defining an inner holder that receives an insertion tool;
a locking device configured to releaseably lock the received insertion tool, the locking device including a locking sleeve and a locking element; and
a spring element configured to load the locking sleeve into a locked position along a longitudinal extension of the at least partially tubular base body,
wherein a contact element is defined at least partially on an inner circumference of the locking sleeve,
wherein a fixing element is defined on an outer circumference of the at least partially tubular base body, and
wherein the spring element is configured to load the fixing element against the contact element.

2. The tool holder according to claim 1, further comprising:
a blocking element associated with the locking sleeve,
wherein the spring element is arranged between the blocking element and the fixing element.

3. The tool holder according to claim 2, wherein the spring element is configured to bear against the blocking element in a circumferential direction of the at least partially tubular base body and/or along the longitudinal extension.

4. The tool holder according to claim 2, wherein the blocking element is (i) displaceable along the longitudinal extension on an outer circumference of the at least partially tubular base body, and/or (ii) rotatable in the circumferential direction of the at least partially tubular base body.

5. The tool holder according to claim 2, further comprising:
a terminating element associated with the blocking element, the terminating element formed in a receptacle arranged on an inner circumference of the locking sleeve.

6. The tool holder according to claim 5, wherein the blocking element is arranged along the longitudinal extension between the spring element and the terminating element.

7. The tool holder according to claim 1, wherein the contact element abuts the fixing element along the longitudinal extension and/or in the circumferential direction of the at least partially tubular base body.

8. The tool holder according to claim 1, wherein the spring element abuts the fixing element along the longitudinal extension and/or in the circumferential direction.

9. The tool holder according to claim 1, wherein the fixing element is arranged along the longitudinal extension between the contact element and the spring element.

10. The tool holder according to claim 1, wherein the contact element is arranged along the longitudinal extension between a receiving area configured to receive the locking element and the fixing element.

11. The tool holder according to claim 10, wherein:
the locking sleeve defines a guide section on an inner circumference of the locking sleeve, the guide section facing the at least partially tubular base body, and the guide section configured to guide the locking element, and
the receiving area is arranged along the longitudinal extension between the guide section and the contact element.

12. The tool holder according to claim 1, wherein:
the inner holder defines (i) a first area at a free end of the inner holder and having a first diameter, and (ii) a second area facing away from the free end and having a second diameter,
the second diameter is smaller than the first diameter, and
an outer circumference of the insertion tool is arranged in the first area.

13. The tool holder according to claim 12, wherein:
the insertion tool is a double-head bit including a machining section, and
the machining section is arranged in the second area.

14. A hand-held power tool, comprising:
a tool holder including:
an at least partially tubular base body defining an inner holder that receives an insertion tool;
a locking device configured to releaseably lock the received insertion tool, the locking device including a locking sleeve and a locking element; and
a spring element configured to load the locking sleeve into a locked position along a longitudinal extension of the at least partially tubular base body,
wherein a contact element is defined at least partially on an inner circumference of the locking sleeve,
wherein a fixing element is defined on an outer circumference of the at least partially tubular base body, and
wherein the spring element is configured to load the fixing element against the contact element.
